(19) United States
(12) Patent Application Publication
(10) Pub. No.: US 2007/0206326 A1
(43) Pub. Date: Sep. 6, 2007

(54) Air bearing surface of a hard disk drive head

(75) Inventor: Shuyu Zhang, Fremont, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/369,506

(22) Filed: Mar. 6, 2006

(51) Int. Cl. G11B 5/60

(52) U.S. Cl. 360/236.3; 360/236.1; 360/235.7; 360/235.6

(57) ABSTRACT

A head for a hard disk drive. The head includes an air bearing surface that has a central pad. The central pad contains the read/write transducers of the head. The air bearing surface has a particle obstruction pad adjacent to the central pad. The obstruction pad creates a mechanical barrier that prevents particles from flowing onto the central pad.

### BACKGROUND OF THE INVENTION

1. Field of the Invention

The present invention relates to an air bearing surface of a head used in a hard disk drive.

2. Background Information

Hard disk drives contain a plurality of magnetic heads that are coupled to rotating disks. The heads can magnetize and sense the magnetic fields of the disks to write and read data, respectively. The heads each have an air bearing surface that cooperates with a flow of air generated by the rotating disks to create an air bearing. The air bearing prevents mechanical wear between the head and the disk.

FIG. 1 shows a typical head air bearing surface 1. The air bearing surface 1 includes a central pad 2 located at a trailing edge of the head. The central pad 2 contains write and read elements that magnetize and sense the magnetic field of an adjacent disk (not shown), respectively. An air bearing is formed between the central pad and the adjacent disk surface.

Contaminants such as small particles may become lodged between the central pad and the disk. The particles may create thermal asperities that degrade the performance of the disk drive. Additionally, the particles may scratch the head and/or disk surface. Although most disk drives are sealed and contain filters, there is no system that is full proof and invariably particles are formed within the drive. It would be desirable to provide a head that minimizes the possibility of a particle becoming lodged between the central pad of the air bearing surface and the adjacent disk surface.

### BRIEF SUMMARY OF THE INVENTION

A head for hard disk drive. The head includes a substrate that has a leading edge and a trailing edge. The substrate further has a central pad that contains at least one transducer and a particle obstruction pad adjacent to the central pad.

### BRIEF DESCRIPTION OF THE DRAWINGS

FIG. 1 is a bottom view of head for a hard disk drive of the prior art;

FIG. 2 is a top view of a hard disk drive;

FIG. 3 is a bottom view of a head of the hard disk drive;

FIG. 4 is a bottom view of the head showing a particle obstruction pad obstructing a particle flowing adjacent to the head.

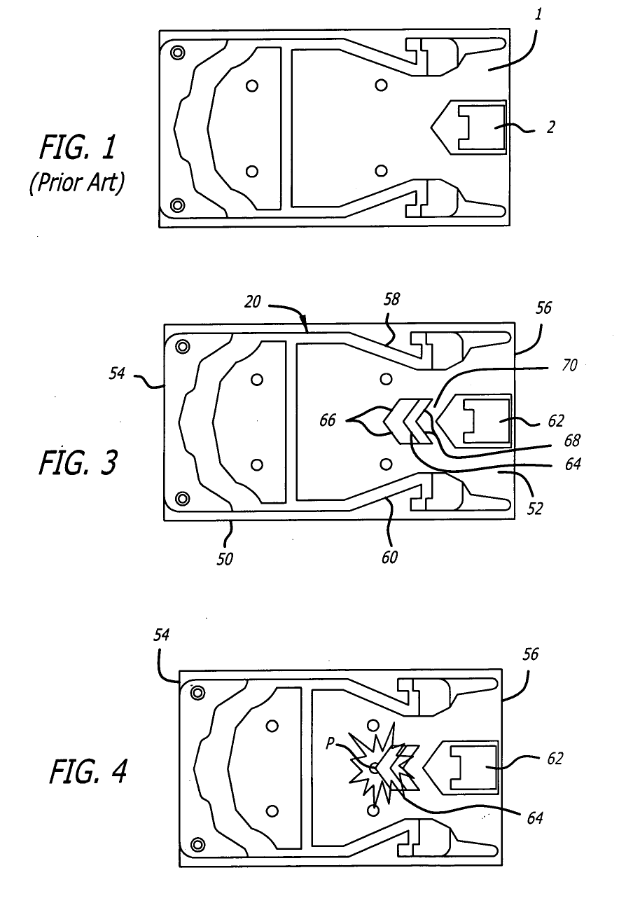

### DETAILED DESCRIPTION

Disclosed is a head for a hard disk drive. The head includes an air bearing surface that has a central pad. The central pad contains the read/write transducers of the head. The air bearing surface has a particle obstruction pad adjacent to the central pad. The obstruction pad creates a mechanical barrier that prevents particles from flowing onto the central pad.

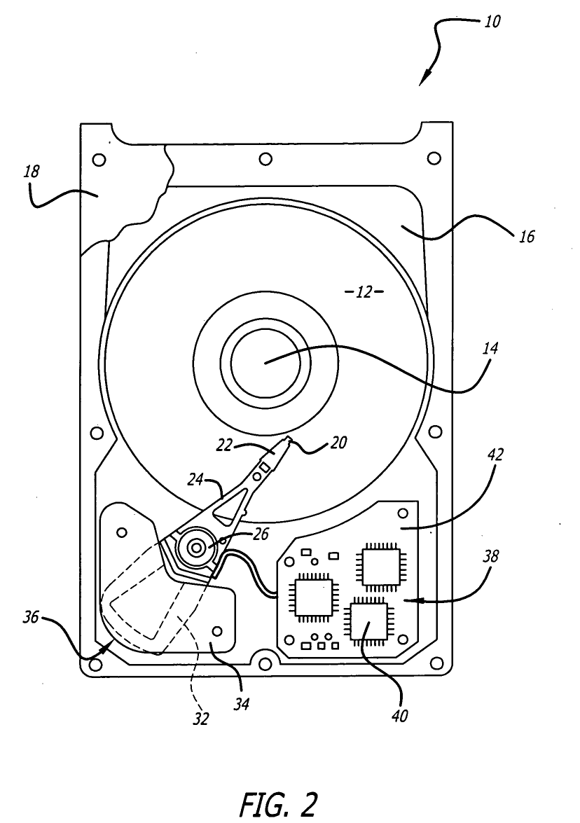

Referring to the drawings more particularly by reference numbers, FIG. 2 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. Each head 20 may have separate write (not shown) and read elements (not shown). The heads 20 are gimbal mounted to a corresponding flexure arm 22. The flexure arms 22 are attached to an actuator arm 24 that is pivotally mounted to the base plate 16 by a bearing assembly 26. A voice coil 32 is attached to the actuator arm 24. The voice coil 32 is coupled to a magnet assembly 34 to create a voice coil motor (VCM) 36. Providing a current to the voice coil 32 will create a torque that swings the actuator arm 24 and moves the heads 20 across the disks 12. The actuator arm 24 and flexure arms 22 can collectively be referred to as an actuator arm assembly.

The hard disk drive 10 may include a printed circuit board assembly 38 that includes a plurality of integrated circuits 40 coupled to a printed circuit board 42. The printed circuit board 42 is coupled to the voice coil 32, heads 20 and spindle motor 14. The cover 18 and base plate 16 enclose the disk 12 and heads 20 of the disk drive 10. The printed circuit board assembly 38 may include a controller that controls the operation of the disk drive

FIG. 3 shows an embodiment of a head 20. The head 20 includes a substrate 50 with an air bearing surface 52 (“ABS”). The substrate 50 has a leading edge 54 and a trailing edge 56. The air bearing surface 52 includes a pair of rails 58 and 60 that extend from the leading edge 54 to the trailing edge 56.

The substrate air bearing surface 52 includes a central pad 62. The central pad 62 includes the read/write transducer element(s) (not shown). The head 20 may have a write element to magnetize an adjacent disk and a separate read element to sense the magnetic field of the disk.

The air bearing surface 52 includes a particle obstruction pad 64 located adjacent to the central pad 62. The particle obstruction pad 64 may be shaped as an arrow with a pair of oblique leading edge surfaces 66 and a pair of trailing edge surfaces 68. The obstruction pad 64 may be separated from the central pad 52 by a channel 70.

FIG. 4 shows the obstruction pad 64 obstructing a particle P that is flowing from the leading edge 54 toward the trailing edge 56. The obstruction pad 64 creates a mechanical barrier that prevents the particle P from flowing into the area of the central pad 62. The oblique angled surfaces 66 deflect the particle P away from the central pad area. The obstruction pad 64 should have a width that will obstruct a particle P that flows from any point along the leading edge 54.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A head for hard disk drive, comprising:
a substrate that has a leading edge and a trailing edge, said substrate further having a central pad that contains at least one transducer, and a particle obstruction pad adjacent to said central pad.

2. The head of claim 1, wherein said particle obstruction pad has a pair of oblique surfaces.

3. The head of claim 1, wherein said particle obstruction pad is separated from said central pad by a channel.

4. The head of claim 1, wherein said substrate includes a pair of side rails.

5. The head of claim 1, wherein said central pad includes a read element and a write element.

6. A hard disk drive, comprising:
a base plate;
a spindle motor coupled to said base plate;
a disk coupled to said spindle motor;
an actuator arm assembly coupled to said base plate;
a voice coil motor coupled to said actuator arm assembly;
a head structurally coupled to said actuator arm assembly and magnetically coupled to said disk, said head including a substrate that has a leading edge and a trailing edge, said substrate further having a central pad that contains at least one transducer, and a particle obstruction pad adjacent to said central pad.

7. The disk drive of claim 6, wherein said particle obstruction pad has a pair of oblique surfaces.

8. The disk drive of claim 6, wherein said particle obstruction pad is separated from said central pad by a channel.

9. The disk drive of claim 6, wherein said substrate includes a pair of side rails.

10. The disk drive of claim 6, wherein said central pad includes a read element and a write element.

11. A head for hard disk drive, comprising:
a substrate that has a leading edge and a trailing edge, said substrate further having a central pad that contains at least one transducer, and particle obstruction means for obstructing a particle from flowing adjacent to said central pad.

12. The head of claim 11, wherein said particle obstruction means includes a central pad that has a pair of oblique surfaces.

13. The head of claim 12, wherein said particle obstruction pad is separated from said central pad by a channel.

14. The head of claim 11, wherein said substrate includes a pair of side rails.

15. The head of claim 12, wherein said central pad includes a read element and a write element.

16. A hard disk drive, comprising:
a base plate;
a spindle motor coupled to said base plate;
a disk coupled to said spindle motor;
an actuator arm assembly coupled to said base plate;
a voice coil motor coupled to said actuator arm assembly;
a head structurally coupled to said actuator arm assembly and magnetically coupled to said disk, said head including a substrate that has a leading edge and a trailing edge, said substrate further having a central pad that contains at least one transducer and particle obstruction means for obstructing a particle from flowing adjacent to said central pad.

17. The disk drive of claim 16, wherein said particle obstruction means includes a central pad that has a pair of oblique surfaces.

18. The disk drive of claim 17, wherein said particle obstruction pad is separated from said central pad by a channel.

19. The disk drive of claim 16, wherein said substrate includes a pair of side rails.

20. The disk drive of claim 17, wherein said central pad includes a read element and a write element.
